(19) United States
(12) Patent Application Publication
(10) Pub. No.: US 2005/0194433 A1
(43) Pub. Date: Sep. 8, 2005

(54) Method and apparatus for facilitating an order

(76) Inventor: Thomas E. Zimmerman, St. Louis, MO (US)

Correspondence Address: INTERNATIONAL PATENT GROUP, 12760 HIGH BLUFF DRIVE, SUITE 300, SAN DIEGO, CA, 92130, US

(21) Appl. No.: 11/068,381

(22) Filed: Mar. 1, 2005

Related U.S. Application Data
(60) Provisional application No. 60/550,711, filed on Mar. 5, 2004.

(51) Int. Cl. G06F 17/60

(52) U.S. Cl. 235/379; 705/26

(57) ABSTRACT

A system for facilitating a customer's order or processing time. The system includes a data apparatus with customer identification, and a reader that determines the customer's pre-determined order and payment method by information provided to the reader on the data apparatus or by accessing a database that has the information and can be accessed by determining the customer identification.

### FIELD OF THE INVENTION

This invention relates generally to a system to facilitate the progression of an order of a customer. More particularly to a method of speeding up the processing time of a customer who orders a determined order regularly.

### BACKGROUND

Regular customers at a place of business serving food usually order the same items on a recurring basis especially at a coffee shop. However, the customer with a “usual” order must wait in line behind people who are not regular customers and who are not familiar with the menu or regular customer who need to present a different method of payment or customers who are in a decision making process. Accordingly, processing time for the “regular” customer is delayed for the business and time for the customer is wasted.

A system and apparatus is needed to facilitate the processing and fulfillment of a predetermined regular order for the customer and facilitate the business' processing time thereby reducing cost to process the order.

### SUMMARY OF INVENTION

There is provided a system for quickly processing an order of a customer whose order does not vary from purchase to purchase and the method of payment is the same or is otherwise known to the business.

Another aspect of the current invention is to provide a card or tag to a customer that identifies the customer to the store, what the customer wants to order, and the payment type(s).

### DETAILED DESCRIPTION OF THE INVENTION

The present invention comprises a data-storage card or tag (Data Apparatus) that is given to a customer. The Data Apparatus idefities the person to the store and the order the customer “normally” orders and payment method(s) to the store. This information is stored either on the Data Apparatus directly or in the store(s)'s computer database which is accessed from a database containing personal identification of the person having the Data Apparatus.

In a preferred example, a regular coffee customer is given an Data Apparatus that can be presented to a card or tag or other type of reader. On the card or tag there is a numerical code or other data that allows the store to determine the item(s) that the customer had pre-selected as the order. The Data Apparatus can have the pre-selected order or it can be stored in the store's database. The payment method like credit card, debit card or other payment type can also be on the card or in the database. So when the customer presents or swipes the Data Apparatus the store knows the customer's precise order and automatically processes the payment.

This allows a customer who always orders the same thing not to have to wait in a line to tell the cashier what is desired. The customer waives or swipes the Data Apparatus, and the order is automatically taken and payment is processed without the hassle of waiting in line and engaging in a time consuming interaction with a clerk.

The Data Apparatus can be scanned, read or a RFIF tag can be used which allow it to merely come into contact with a reader or receiver.

The Data Apparatus can optionally contain on it prepaid amounts or prepaid amounts can be stored in the business's database. The Data Apparatus can be loaded at the time the customer acquires the card or be topped up during another visit.

If the amount is not actually stored on the card but in the business' computer the customer could make payment to the card by calling a customer call number, visiting a web site or paying at another visit. Additionally, the charge card, debit card, account number can be stored in the computer and if the amounts in the account drops below a preset limit say 50 dollars then a charge is made against the customer payment type like a charge card.

The order that the customer will want to make can be done in several fashions. A web site could be maintained by the business that will allow the customer to setup the preset set order or it can be done when the customer visits the store or by calling a toll free number. The business can also maintain a database of what the customer has ordered in the past and “predict” what the customer might want. If the business is “predicting” the order it may want to have a means to have the customer verify the order before it is placed.

If a business has significant number of customers who regularly order the same items every time they visit this could allow the business to reduce the number of employees that would normally be required to staff the business. As various changes could be made in the above methods and compositions without departing from the scope of the invention, it is intended that all matter contained in the above description shall be interpreted as-illustrative and not in a limiting sense.

1. A method of conducting a transaction comprising:
Providing a data apparatus to a customer;
said data apparatus having said customer's identification associated with it;
Determining the customer's pre-selected order by using said customer identification;
Determining said customer's payment type based on said customer's identification;
Having the cost of said pre-selected order applied to said customer's payment method; and
Delivering said pre-selected order to said customer.

2. The method as recited in claim 1 wherein said pre-determined order is selected from food and beverage.

3. The method as recited in claim 1 wherein said pre-determined order is a coffee beverage.

4. The method as recited in claim 2 further comprising giving the customer a receipt at the time the order is taken.

5. The method as recited in claim 2 wherein said customer name, pre-selected order and payment method are stored in the store's database.

6. The method as recited in claim 2 wherein said customer name, pre-selected order and payment method are stored on said data apparatus.

7. The method as recited in claim 5 wherein said data apparatus is a card or a tag.

8. The method as recited in claim 1 wherein said pre-selected order is created at the time the data apparatus is given to said customer, at the store taking the order, at a website set up to create said pre-selected order or by phone.
A system to facilitate an order of a customer comprising:
A data apparatus containing customer identification;
A reader that can determine said customer's pre-determined order and payment method by information provided to said reader on the data apparatus or by accessing a database that has said information and can be accessed by determining said customer identification.
The system as recited in claim 8 wherein said pre-determined order is selected from food and beverage.
The system as recited in claim 9 wherein said pre-determined order is a coffee beverage.
The system as recited in claim 8 wherein said customer's name, pre-selected order and payment method are stored in the store's database.
The system as recited in claim 8 wherein said pre-selected order and payment method are stored on said data apparatus.
The system as recited in claim 8 wherein said data apparatus is a card or a tag.
The system as recited in claim 8 wherein said tag is an RFIF tag.,
The system as recited in claim 8 wherein said pre-selected order is created at the time the data apparatus is given to said customer, at the store taking the order, at a website set up to create said pre-selected order or by phone.
The system as recited in claim 8 further comprising a monitor that displays said pre-selected order to said customer and the store for order fulfillment.
